(19) United States
(12) Patent Application Publication
(10) Pub. No.: US 2007/0116260 A1
(43) Pub. Date: May 24, 2007

(54) Termination circuit for broadband signal lines

(76) Inventors: Roy N. Sodersjerna, Westford, MA (US); Julius Caesar A. Reyes, San Ramon, CA (US); Philip Simmons, San Jose, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/281,767

(22) Filed: Nov. 16, 2005

(51) Int. Cl. H04M 1/76; H04M 7/00; H04M 9/00

(52) U.S. Cl. 379/414

(57) ABSTRACT

A termination circuit includes a low-pass filter configured to couple to a first signal line and a second signal line. An activation circuit is coupled to the low-pass filter. A termination impedance is coupled to the activation circuit. A detector circuit is coupled to the low-pass filter. The detector circuit is configured to detect a signal on the first signal line and the second signal line. A control circuit is coupled to an output from the detector circuit. The control circuit is configured to determine if the signal corresponds to a predefined class of telephone service and to select a state of the activation circuit in accordance with the determination.

### FIELD OF THE INVENTION

The present invention relates generally to termination circuits, and more specifically, to termination circuit for broadband signal lines.

### BACKGROUND OF THE INVENTION

Many signal lines in communications systems, such as those used in some telephone communications systems, are susceptible to corrosion. One existing approach to reducing corrosion is to transmit a transient current along the signal lines. For example, in some telephone systems, such as those that implement what is known as plain old telephone service (POTS), the current associated with ringing the telephone flowing through a termination resistance reduces corrosion of the telephone signal lines. The termination resistance is typically coupled across the tip and ring signal lines.

Currently, telephone signal lines are being used to provide services other than or in addition to POTS. For example, high frequency broadband signals corresponding to services such as digital subscriber line (DSL) may be transmitted using telephone signal lines. If the same telephone signal lines also provide POTS, the aforementioned ringing currents will reduce corrosion of the telephone signal lines. However, telephone signal lines that are used to provide DSL services but are not used to provide POTS, sometimes called dry DSL lines, are more susceptible to corrosion. This may degrade the telephone signal lines, adversely affecting DSL performance and even resulting in a loss of service.

One existing solution to this problem is to provide a sealing or wetting current to dry DSL lines to reduce corrosion and, thereby, ensure performance and quality of service. This approach, however, is not compatible with POTS (it can disrupt such service and/or damage customer premise equipment). As a consequence, depending on the types of service provided, a termination resistance, a filter and/or a sealing current may be used on the telephone signal lines. Unfortunately, the provisioning or service configuration for a given customer may not be known to a service provider or may change as a function of time. In addition, supporting different models or types of customer premises equipment for these different service configurations may increase the complexity and/or expense associated with providing these services.

There is a need, therefore, for improved termination circuitry for use with signal lines.

### SUMMARY

Embodiments of a termination circuit are described. In some embodiments, a termination circuit includes a low-pass filter configured to couple to a first signal line and a second signal line. An activation circuit is coupled the low-pass filter. A termination impedance is coupled to the activation circuit. A detector circuit is coupled to the low-pass filter. The detector circuit is configured to detect a signal on the first signal line and the second signal line. A control circuit is coupled to an output from the detector circuit. The control circuit is configured to determine if the signal corresponds to a predefined class of telephone service and to select a state of the activation circuit in accordance with this determination.

The termination impedance may be a resistor. The signal may be a DC voltage.

The predefined class of telephone service may include plain old telephone service (POTS). In some embodiments, the predefined class of telephone service consists solely of data transmission services.

The detector circuit may be configured to detect the signal independent of a polarity of signals on the first signal line and the second signal line.

The control circuit may sample the output from the detector circuit. The control circuit may be configured to report the state of the activation circuit to a broadband processor. In some embodiments, the control circuit includes a memory, a processor and a program, stored in the memory and executed by the processor. The program may include instructions for the selecting of the state of the activation circuit in accordance with the determining if the signal corresponds to the predefined class of telephone service. The control circuit may be configured to determine if a sealing current is present.

The state of the activation circuit selected by the control circuit may include a state in which the first signal line and second signal line are coupled to first and second terminals of the termination impedance, respectively, if the signal corresponding to the predetermined class of telephone service is absent. The state of the activation circuit selected by the control circuit may include a state in which the first signal line and second signal line are decoupled from first and second terminals of the termination impedance, respectively, if the signal corresponding to the predetermined class of telephone service is present.

In some embodiments, the first signal line corresponds to a tip signal line and the second signal corresponds to a ring signal line. In some embodiments, the second signal line corresponds to a tip signal line and the first signal corresponds to a ring signal line.

In some embodiments, a current limiter circuit is coupled to outputs of the low-pass filter and inputs of the activation circuit. In some embodiments, the current limiter circuit has inputs coupled to the activation circuit and the low-pass filter, and outputs coupled to the termination impedance.

The embodiments of the termination circuit at least partially overcome the previously described problems with existing termination approaches.

### BRIEF DESCRIPTION OF THE DRAWINGS

Additional objects and features of the invention will be more readily apparent from the following detailed description and appended claims when taken in conjunction with the drawings.

FIG. 1 is a block diagram illustrating an embodiment of a circuit.

FIG. 2 is a block diagram illustrating an embodiment of a circuit.

FIG. 3 is a block diagram illustrating an embodiment of a portion of a termination circuit.

FIG. 4 is a block diagram illustrating an embodiment of a detector circuit.

FIG. 5 is a block diagram illustrating an embodiment of a control circuit.

FIG. 6 is a flow chart illustrating an embodiment of using a termination circuit.

Like reference numerals refer to corresponding parts throughout the several views of the drawings.

### DESCRIPTION OF EMBODIMENTS

Reference will now be made in detail to embodiments of the invention, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the present invention.

Embodiments of a termination circuit are described. The termination circuit is configured to determine the presence or absence of a predefined class of telephone service on signal lines and to select a termination impedance of the signal lines in accordance with the presence or absence. The termination circuit may determine a signal corresponding to the predefined class of telephone service. The termination circuit may be configured to determine the signal independent of its polarity on the signal lines. The selection of the termination impedance may be repeated periodically or after at least a predetermined time interval, such as 1, 5, 10, 120, 300, 1800 and/or 3600 seconds. In some embodiments, the termination circuit may have a static configuration.

The predefined class of telephone service may include plain old telephone service (POTS) and/or data transmission services, such as digital subscriber line or DSL. DSL may include, but is not limited to, asymmetric digital subscriber line (ADSL), ADSL2, ADSL2+, very high bit-rate digital subscriber line (VDSL) and other types of DSL technologies. In some embodiments, the predefined class of telephone service consists solely of data transmission services, such as DSL. The signal lines may be wires in a telephone system. In an exemplary embodiment, the signal lines may be the tip and ring signal lines.

In an exemplary embodiment, the termination circuit determines if the signal lines corresponds to a dry DSL line or pair of lines (i.e., that POTS is not provided on the signal lines) based on the absence of a DC voltage magnitude exceeding a predefined threshold for a series of consecutive voltage samples. (A dry DSL line is also sometimes referred to as an all digital loop.) The presence of a DC voltage magnitude exceeding the voltage threshold for one of the series of consecutive voltage measurements may indicate the presence of a sealing current, which is provided by a service provider to reduce corrosion on a dry DSL line. Typically, sealing currents are transient pulses (each lasting between milliseconds and seconds) having a voltage greater than 32 V and a current of some 20 mA.

If the signal lines correspond to a dry DSL line, as indicated by a DC voltage magnitude that is less than the predefined threshold for some of the series of consecutive voltage samples, a finite termination impedance, such as a resistance, may be coupled across the signal lines. If the DC voltage magnitude exceeds the predefined threshold for the series of consecutive voltage samples (i.e., the signal lines do not correspond to a dry DSL line), the termination impedance may not be coupled across the signal lines (i.e., the termination is left open or an infinite DC resistance). In an exemplary embodiment, the DC voltage magnitude on a typical dry DSL line is approximately less than 3.0 V, except when the transient sealing current is being applied, and the termination impedance is approximately 200 Ω.

In some embodiments, the termination circuit may include a current limiter circuit. The current limiter circuit may provide at least partial over-voltage and/or current surge protection, for example, against current surges associated with lightning strikes. In some embodiments, the current limiter circuit may meet the I-V template defined in Telcordia TR-NWT-000057 Issue 2 “Functional Criteria for Digital Loop Carrier Systems” January 1993, ANSI Standard T1.601, “American National Standard for Telecommunications—Integrated Services Digital Network (ISDN) Basic Access Interface for Use on Metallic Loops for Application on the Network Side of the NT (Layer 1 Specification),” and ITU-T Recommendation G.992.3 “Asymmetrical Digital Subscriber Line-2 (ADSL2) Transceivers” Annex I. In an exemplary embodiment, the over voltage protection of the current limiter circuit provides protection up to at least 300 V and the current surge protection limits current to approximately 28 mA.

By determining the presence of signals corresponding to POTS and/or sealing currents, the termination circuit can be adapted and/or dynamically configured for use in a wide variety of provisioning or service configurations (such as POTS only, POTS plus DSL, and/or DSL only). This may allow the service provider, such as telephone carrier, to support multiple customers or users with common customer premises equipment that includes the termination circuit, thereby reducing the cost and complexity of providing service. In addition, the configuration of this common customer premises equipment may be modified (based on control signals provided by the service provider) and/or self-configured to accommodate changes in customer service over time. In this way, the termination circuit may, at least in part, address the challenges posed by the existing approaches.

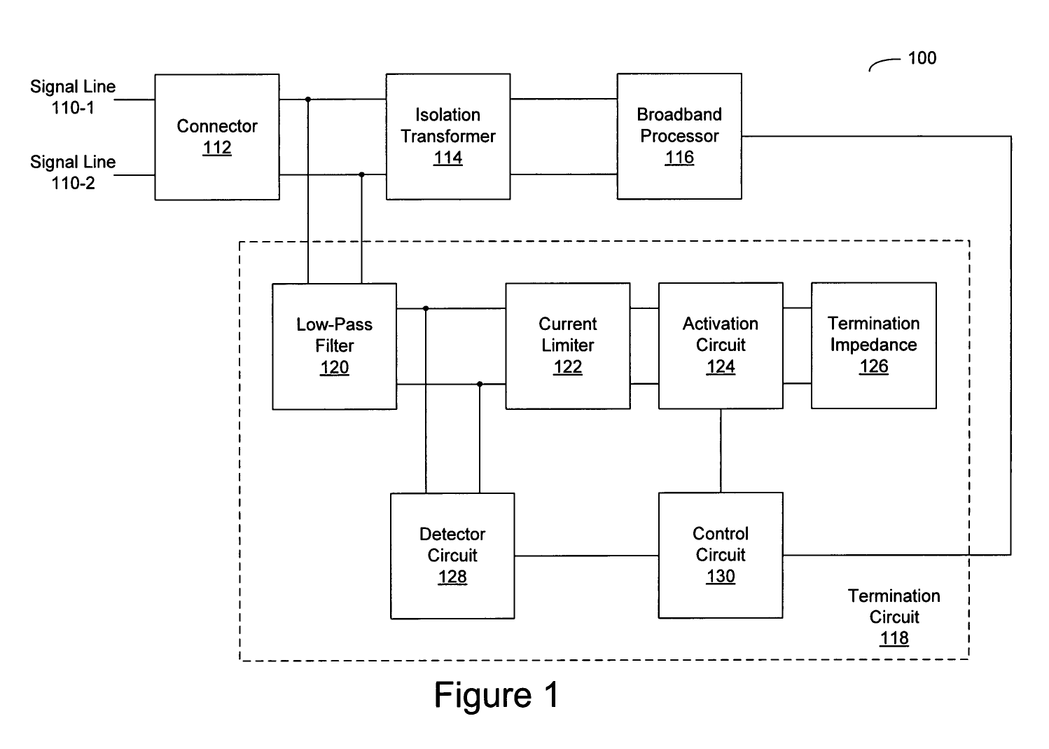

Attention is now directed towards embodiments of the termination circuit. FIG. 1 is a block diagram illustrating an embodiment of a circuit 100. The circuit 100 may include a connector 112 coupled to signal lines 110. In an exemplary embodiment, the signal lines 110 are the tip and ring signal lines in a telephone system. The circuit 100 includes an isolation transformer 114 and a broadband processor 116, for transmitting and receiving broadband signals, such as those corresponding to DSL.

The circuit 100 may also include a termination circuit 118. The termination circuit 118 may be configured for coupling to the signal lines 110. The termination circuit 100 may include a low-pass filter 120, a current limiter 122, an activation circuit 124, a termination impedance 126, a detector circuit 128 and a control circuit 130.

The low-pass filter 120 may be used to prevent the termination impedance 126 from affecting an interface, such as a DSL interface, in the broadband processor 116, when the termination impedance 126 is coupled across the signal lines 110. In an exemplary embodiment, the low-pass filter 120 may be a third-order Chebyshev II filter having a pass band from 0 to 4 kHz with less than 1 dB of loss. A stop band including 25 KHz may have more than 35 dB of attenuation.

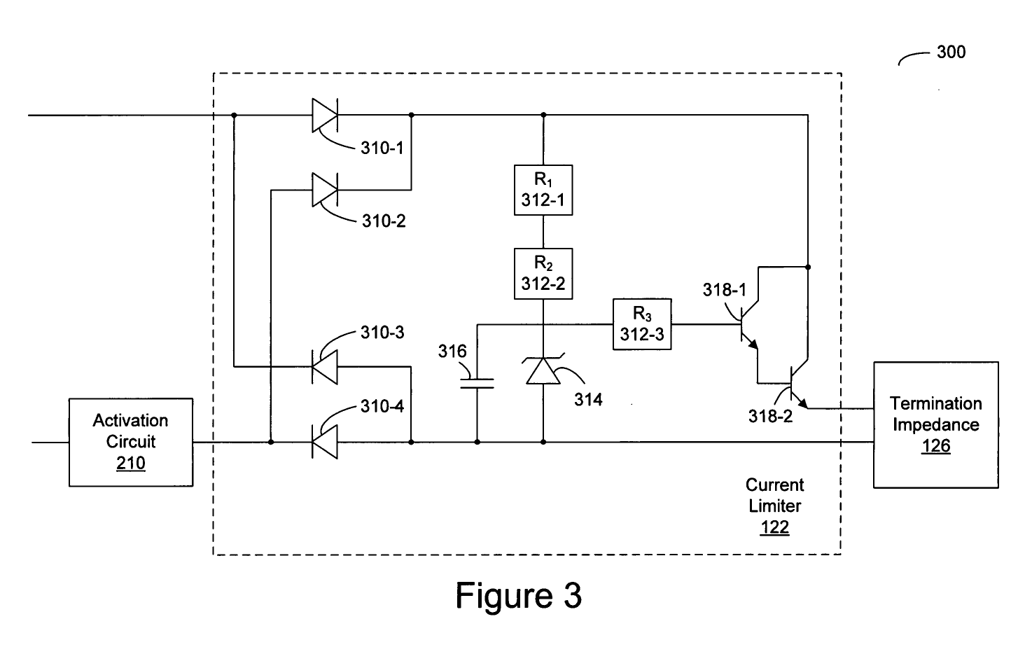

The current limiter 122 may be capable of drawing between 1 and 28 mA of sealing current from a remote circuit. The current limiter 122 may cap the current at approximately 28 mA. The current limiter 122 is described further below with reference to FIG. 3.

The activation circuit 124 may enable or disable coupling of the termination impedance 126 across the signal lines 110 in accordance with a state or control signal provided by the control circuit 130. The activation circuit 124 may be an electromechanical or solid state device. In an exemplary embodiment, the activation circuit 124 may include an opto-isolated control input from the control circuit 130.

The termination impedance 126 may be a resistor. In an exemplary embodiment, the termination impedance is approximately 200 Ω.

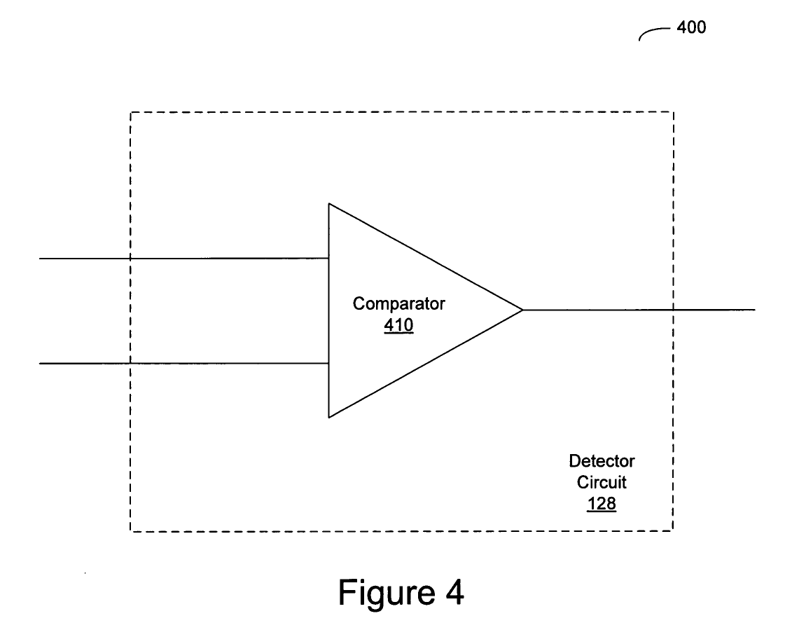

The detector circuit 128 may detect the presence or absence of a signal on the signal lines, such as a DC voltage magnitude that exceeds a predetermined threshold. In an exemplary embodiment, the predetermined threshold is 3.5 V. The detector circuit 128 may detect or determine the presence or absence of the signal independently of an on-off hook state when the POTS is provided on the signal lines 110. The detector circuit 128 may be configured to detect the signal on the signal lines 110 without regard to the polarity of the signal on the signal lines 110, such as a tip-ring polarity or a ring-tip polarity. The detector circuit 128 may perform a series of measurements of the signal during a time interval. The detector circuit is described further below with reference to FIG. 4.

An output from the detector circuit 128 is coupled to the control circuit 130. The control circuit 130 may sample the signal periodically or after at least a pre-determined time interval, such as 1, 5, 10, 60, 120, 300, 1800 and/or 3600 seconds. The control circuit 130 may be configured to determine whether or not a predefined class of telephone service is provided on the signal lines 110 in accordance with the signal and/or the output from the detector circuit 128. In particular, the control circuit 130 may be configured to determine if POTS is provided on the signal lines 110, if DSL and POTS are provided on the signal lines 110, and/or if DSL without POTS is provided on the signal lines 110. The control circuit 130 may make this determination based on the presence of a DC voltage, the magnitude of which falls below a predetermined threshold for a predetermined number of samples (e.g., at least N consecutive samples, where N is an integer greater than one). Alternately, the control circuit 130 may make this determination based on the presence of a DC voltage, the magnitude of which exceeds a predetermined threshold for a predetermined number of samples. The control circuit 130 may select a state of the activation circuit 124 based on this determination.

In an exemplary embodiment, a default state of the activation circuit 124 may be disabled, i.e., that the termination impedance 126 is not coupled across the signal lines 110. If a series of consecutive samples (for example, five samples) from the detector circuit 128 are false, i.e., the DC voltage magnitude did not exceed the predetermined threshold for these samples, the state of the activation circuit 124 may be set to enabled, i.e., the termination impedance 126 may be coupled across the signal lines 110. This corresponds to neither POTS signals nor a sealing current being present on the signal lines 110. If some but not all of the series of samples are true, i.e., the DC voltage magnitude exceeded the predetermined threshold for some of the samples, the state of the activation circuit 124 may be set to enabled. For example, the requirement for enabling the activation circuit 124 may be a requirement that at least N out of M, (e.g., at least two out of five) consecutive samples do not exceed the predetermined threshold, where M is larger than N and both are integers larger than one. This corresponds to the presence of a sealing current on the signal lines 110 but an absence of POTS signals. If the series of samples from the detector circuit 128 are all true, i.e., the DC voltage magnitude did exceed the predetermined threshold for all of these samples, the state of the activation circuit 124 may be set to disabled. This corresponds to POTS signals being present on the signal lines 110. In this way, the control circuit 130 may distinguish signals on the signal lines 110 corresponding to POTS from sealing currents on a dry DSL line and enable or disable the coupling of the termination impedance 126 across the signal lines 110.

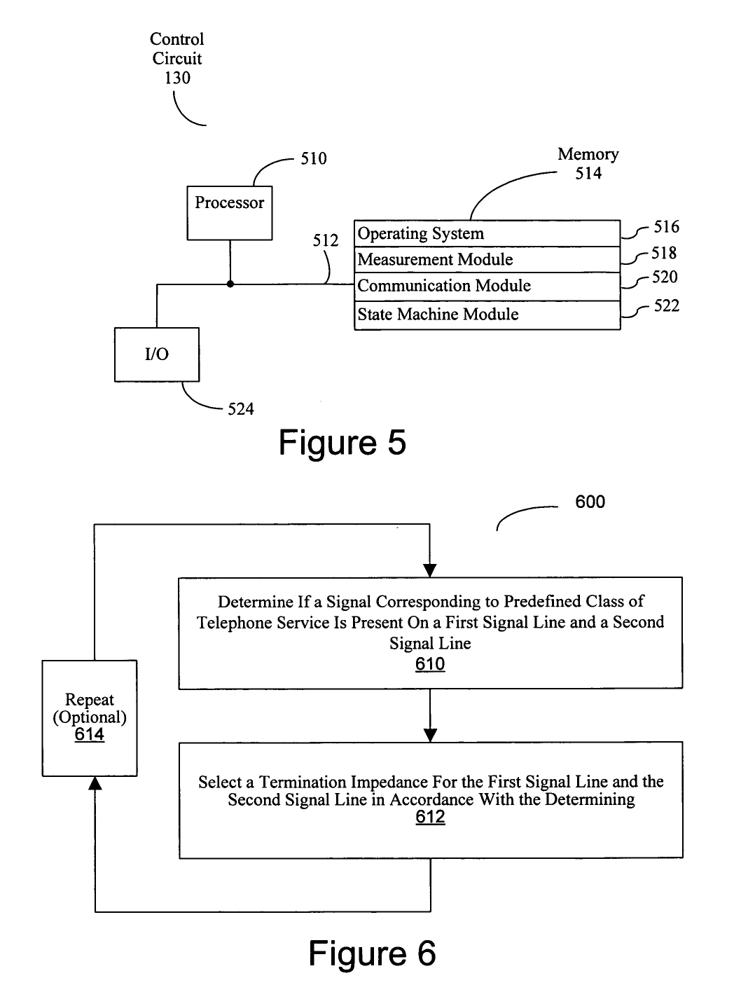

In some embodiments, the control circuit 130 may detect changes on the signal lines 110, such as a disconnection and/or reconnection to the signal lines 110. In some embodiments, the control circuit 130 may allow a static configuration to be set based on a control signal from the service provider and/or the broadband processor 116. The static configuration may always enable the activation circuit 124 or always disable the activation circuit 124. The control circuit 130 may be configured to report status information to the broadband processor 116. The status information may include information corresponding to detection of POTS signals on the signal lines 110, an absence of POTS signals on the signal lines 110, and/or detection of a sealing current on the signal lines 110. In some embodiments, the control circuit 130 may include a state machine to perform at least some of the aforementioned functions. The control circuit 130 is described further below with reference to FIG. 5.

In some embodiments, the circuit 100 may include fewer or additional components and/or circuits. In some embodiments, two or more components and/or circuits may be combined. In some embodiments, positions of one or more components and/or circuits may be changed. The circuit 100 may be implemented using discrete components and/or one or more integrated components.

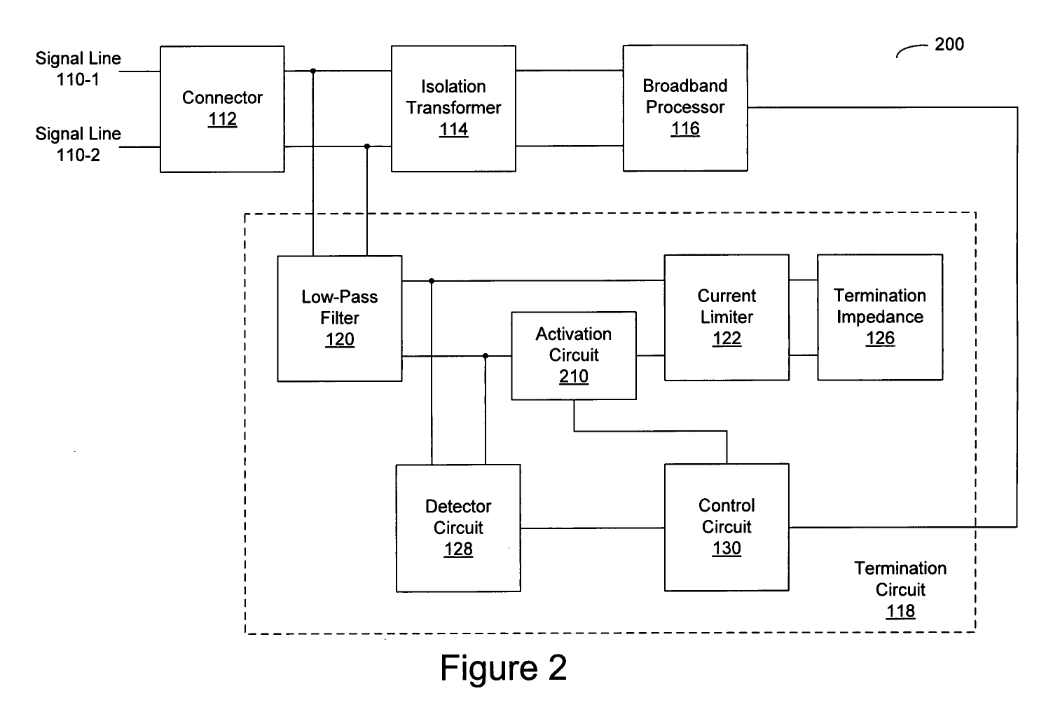

FIG. 2 is a block diagram illustrating an embodiment of a circuit 200. In the circuit 200, activation circuit 210 has been repositioned relative to the position of the activation circuit 124 in the circuit 100 (FIG. 1). In particular, the activation circuit 210 is coupled to the low-pass filter 120 and the current limiter 122, as opposed to the current limiter 122 and the termination impedance 126.

FIG. 3 is a block diagram illustrating an embodiment 300 of a portion of a termination circuit. The current limiter circuit 122 includes diodes 310, resistors 312, Zener diode 314, capacitor 316, and transistors 318 in a Darlington configuration. In the embodiment 300, the termination impedance 126 includes a finite DC resistance. A range of the current limiter circuit 122 may be changed by changing a voltage of the Zener diode 314 and/or the termination impedance 126. In an exemplary embodiment, the current limiter circuit 122 allows approximately 1 to 28 mA of current to flow and has a maximum DC input voltage of approximately 300 or 350 V.

FIG. 4 is a block diagram illustrating an embodiment 400 of the detector circuit 128. A comparator 410 is used to detect the presence or absence of the signal on the signal lines 110 (FIG. 1) independent of the signal polarity. The detector circuit 128 may be a secondary low voltage (SELV) circuit in order to isolate it from remote circuits. In particular, such isolation may be provided using large series resistors (not shown), such as 3.3 MΩ resistors. The detector circuit 128 may comply with telecommunication creepage clearance requirements.

FIG. 5 is a block diagram illustrating an embodiment of the control circuit 130. The control circuit 130 may include one or more processors or central processing units (CPUs) 510, a memory 514, an input/output (I/O) circuit 524, and one or more interface lines 512 for coupling these components to one another. The one or more interface lines 512 may be a communications bus.

The memory 514 may include high-speed random access memory and/or non-volatile memory. The memory 514 may store an embedded operating system 516, including but not limited to Windows or Linux, that includes procedures (or a set of instructions) for handling basic system services and for performing hardware dependent tasks. The memory 514 may also store communication procedures (or a set of instructions) in a communication module 520. The communication procedures may be used for communicating with the broadband processor 116 (FIG. 1).

The memory 514 may also include a measurement module 518 (or a set of instructions) for sampling the output of the detection circuit 128 (FIG. 1) via the I/O circuit 524 and a state machine module 522 (or a set of instructions) for determining the presence of one or more predefined classes of telephone service and selecting the corresponding state of the activation circuit 124 (FIG. 1).

Each of the above identified modules and applications correspond to a set of instructions for performing one or more of the functions described above. These modules (i.e., sets of instructions) need not be implemented as separate software programs, procedures or modules. The various modules and sub-modules may be rearranged and/or combined. The memory 514 may include additional modules and/or sub-modules, or fewer modules and/or sub-modules. The memory 514, therefore, may include a subset or a superset of the above identified modules and/or sub-modules.

Attention is now directed towards embodiments of using a termination circuit. FIG. 6 is a flow chart illustrating an embodiment 600 of using a termination circuit. A presence or absence of a signal corresponding to predefined class of telephone service on a first signal line and a second signal line is determined (610). A termination impedance for the first signal line and the second signal line is selected in accordance with the determining (612). The operations may be optionally repeated one or more times (614).

In some embodiments, there may be additional or fewer operations. Two or more operations may be combined into a single operation. A position of at least one operation may be changed. In some embodiments, at least some of the operations may be executed serially or in parallel (e.g., using parallel processors or a multi-threading environment).

The foregoing description, for purposes of explanation, used specific nomenclature to provide a thorough understanding of the invention. However, it will be apparent to one skilled in the art that the specific details are not required in order to practice the invention. The embodiments were chosen and described in order to best explain the principles of the invention and its practical applications, to thereby enable others skilled in the art to best utilize the invention and various embodiments with various modifications as are suited to the particular use contemplated. Thus, the foregoing disclosure is not intended to be exhaustive or to limit the invention to the precise forms disclosed. Many modifications and variations are possible in view of the above teachings.

It is intended that the scope of the invention be defined by the following claims and their equivalents.

What is claimed:

1. A circuit, comprising:
a low-pass filter configured to couple to a first signal line and a second signal line;
an activation circuit coupled the low-pass filter;
a termination impedance coupled to the activation circuit;
a detector circuit coupled to the low-pass filter, and wherein the detector circuit is configured to detect a signal on the first signal line and the second signal line; and
control circuit coupled to an output from the detector circuit, wherein the control circuit is configured to determine if the signal corresponds to a predefined class of telephone service and to select a state of the activation circuit in accordance with the determination.

2. The circuit of claim 1, wherein the first signal line corresponds to a tip signal line and the second signal corresponds to a ring signal line.

3. The circuit of claim 1, wherein the second signal line corresponds to a tip signal line and the first signal corresponds to a ring signal line.

4. The circuit of claim 1, wherein the termination impedance comprises a resistor.

5. The circuit of claim 1, further comprising a current limiter circuit coupled to outputs of the low-pass filter and inputs of the activation circuit.

6. The circuit of claim 5, wherein the current limiter circuit restricts a current to approximately less than 28 mA.

7. The circuit of claim 1, further comprising a current limiter circuit having inputs coupled to the activation circuit and the low-pass filter, and outputs coupled to the termination impedance.

8. The circuit of claim 7, wherein the current limiter circuit restricts a current to approximately less than 28 mA.

9. The circuit of claim 1, wherein the detector circuit is configured to detect the signal independent of a polarity of signals on the first signal line and the second signal line.

10. The circuit of claim 1, wherein the state of the activation circuit selected by the control circuit comprises a state in which the first signal line and second signal line are coupled to first and second terminals of the termination impedance, respectively, if the signal corresponding to the predetermined class of telephone service is absent.

11. The circuit of claim 1, wherein the state of the activation circuit selected by the control circuit comprises a state in which the first signal line and second signal line are decoupled from first and second terminals of the termination impedance, respectively, if the signal corresponding to the predetermined class of telephone service is present.

12. The circuit of claim 1, wherein the control circuit is configured to determine if a sealing current is present.

13. The circuit of claim 1, wherein the control circuit samples an output from the detector circuit.

14. The circuit of claim 1, wherein the signal is a DC voltage.

15. The circuit of claim 14, wherein the detector circuit is configured to detect if the DC voltage has a magnitude greater than 3.5 V.

16. The circuit of claim 1, wherein the control circuit is configured to report the state of the activation circuit to a broadband processor.

17. The circuit of claim 1, wherein the control circuit includes:
a memory;
a processor; and
a program, stored in the memory and executed by the processor, the program including:
instructions for the selecting of the state of the activation circuit in accordance with the determining if the signal corresponds to the predefined class of telephone service.

18. The circuit of claim 1, wherein the predefined class of telephone service includes plain old telephone service (POTS).

19. The circuit of claim 1, wherein the predefined class of telephone service consists solely of data transmission services.

20. A method, comprising:
determining if a signal corresponding to a predefined class of telephone service is present on a first signal line and a second signal line; and
selecting a termination impedance for the first signal line and the second signal line in accordance with the determining.

21. The method of claim 17, wherein the signal is a DC voltage.

22. A circuit, comprising:
a low-pass filter configured to couple to a first signal line and a second signal line;
an activation circuit coupled the low-pass filter;
a termination impedance coupled to the activation circuit;
first means for detecting a signal on the first signal line and the second signal line; and
second means for determining if the signal corresponds to a predefined class of telephone service and for selecting a state of the activation circuit in accordance with the determination.
